(19) United States
(12) Patent Application Publication
(10) Pub. No.: US 2007/0029153 A1
(43) Pub. Date: Feb. 8, 2007

(54) One-way clutch

(75) Inventors: Akira Iwano, Fukuroi-shi (JP); Yukiyoshi Suzuki, Fukuroi-shi (JP); Kazuhiko Muramatsu, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 11/495,551

(22) Filed: Jul. 31, 2006

(30) Foreign Application Priority Data
Aug. 2, 2005 (JP) 2005-224054

(51) Int. Cl. F16D 41/069; F16D 13/60

(52) U.S. Cl. 192/45.1; 192/107 T

(57) ABSTRACT

The present invention provides a one-way clutch comprising an outer race, an inner race rotatable relative to the outer race and torque transmitting members for transmitting torque between the outer race and the inner race and wherein a plurality of grooves extending substantially in a circumferential direction are formed in an outer peripheral track surface of the inner race.

### BACKGROUND OF THE INVENTION

1. Field of the Invention

The present invention relates to one-way clutches of sprag type and roller type used in vehicles or the like. More particularly, the present invention relates to a one-way clutch in which a circumferential groove is formed in outer peripheral surface of an inner race.

2. Related Background Art

In general, a one-way clutch comprises an outer race, an inner race rotatable relative to the outer race, and torque transmitting members for transmitting torque between the outer race and the inner race. When the inner and outer races are rotated relative to each other, for example, toe torque transmitting members are engaged by an outer peripheral surface of the inner race, thereby transmitting the torque between the inner and outer races.

In conventional one-way clutches, if viscosity of lubricating oil is increased in a low temperature condition (for example, −20° C. to −40° C. or below), when the one-way clutch is transferred from an idle rotation condition to an engaging condition, there is a danger of generating a problem in which normal or correct engagement cannot be achieved to cause continuous slipping, thereby deteriorating an engagement function of the one-way clutch.

In order to sole such a problem, although it can be considered that, by increasing a force of a spring for applying loads to sprags or rollers as the torque transmitting member in an engaging direction, surface pressure on the engaging surface is increased to facilitate the cutting of an oil film, if the spring force is increased, drag torque of the one-way clutch during the idle rotation is increased, with the result that, when the one-way clutch is used in a motor vehicle or the like, fuel consumption will be increased.

### SUMMARY OF THE INVENTION

Accordingly, an object of the present invention is to provide a one-way clutch in which an adequate engaging ability can be maintained even in a low temperature condition that viscosity of lubricating oil is increased, drag torque during an idle rotation can be reduced and sliding wear between an inner race and torque transmitting member can be prevented.

To achieve the above object, the present invention provides a one-way clutch comprising an outer race, an inner race rotatable relative to the outer race and torque transmitting members for transmitting torque between the outer race and the inner race and wherein a plurality of grooves extending substantially in a circumferential direction are formed in an outer peripheral track surface of the inner race.

According to the present invention, the following advantages can be obtained.

Since the plurality of grooves extending substantially in the circumferential direction are formed in the outer peripheral track surface of the inner race, even in a low temperature condition that viscosity of lubricating oil is increased, an adequate engaging ability can be maintained. The reason is that, Due to the presence of the grooves of the inner race, an oil film between sprags or rollers and the inner race can be removed smoothly. Further, drag torque during an idle rotation can be reduced and sliding wear between the sprags or the rollers and the inner race can be prevented.

By forming the plurality of grooves extending substantially in the circumferential direction in the outer peripheral track surface of the inner race of the one-way clutch, even in a low temperature condition that viscosity of lubricating oil is increased, an adequate engaging ability can be maintained.

### BRIEF DESCRIPTION OF THE DRAWINGS

FIG. 1 is a partial radial sectional view of a one-way clutch according to an embodiment of the present invention;

FIG. 2 is a perspective view of an inner race of the one-way clutch shown in FIG. 1;

FIG. 3 is an enlarged partial sectional view of grooves; and

FIG. 4 is a sectional view showing a step for flattening edges of the grooves by means of an urging tool.

### DESCRIPTION OF THE PREFERRED EMBODIMENTS

Now, an embodiment of the present invention will be fully explained with reference to the accompanying drawings. Incidentally, in the drawings, the same or similar elements are designated by the same reference numerals. Further, it should be noted that the embodiment which will be described hereinbelow is merely exemplary and does not limit the present invention at all.

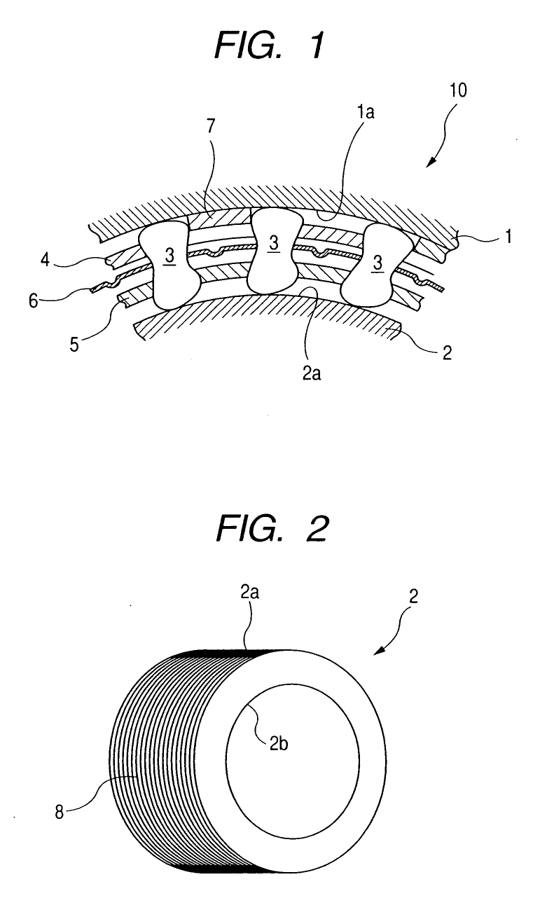

FIG. 1 is a partial radial sectional view of a one-way clutch 10 according to an embodiment of the present invention. The one-way clutch 10 comprises an outer race 1 having an inner peripheral track surface 1a, an inner race 2 arranged to be rotatable relative to the outer race 1 and having an outer peripheral track surface 2a, and sprags 3 as torque transmitting members for transmitting torque between the outer race 1 and the inner race 2.

The sprags 3 are held between an outer holder 4 and an inner holder 5 which are disposed between the outer race 1 and the inner race 2. Further, a ribbon spring 6 is provided between the outer holder 4 and the inner holder 5 to apply cocking moment to the sprags 3 so that the sprags can be engaged by the outer peripheral track surface 2a of the inner race 2. T-shaped bars 7 offset radially outwardly are provided on portions of the outer holder 4 to be contacted with the outer race 1, thereby generating predetermined drag torque.

FIG. 2 is a perspective view of the inner race 2 of the one-way clutch 10. shown in FIG. 1. The inner race 2 is provided with the outer peripheral track surface 2a with which the sprags 3 are engaged, and an inner peripheral surface 2b into which a rotary member (not shown) is fitted. A plurality of grooves 8 extending substantially in a circumferential direction are formed in the outer peripheral track surface 2a of the inner race 2.

Each groove 8 is formed as a single semi-circular groove continuous along the circumferential direction of the outer peripheral track surface 2a. The plural grooves 8 are formed at a pitch of 0.015 to 0.5 mm along an axial direction and each groove has a depth of 0.05 to 0.5 mm and a width of 0.05 to 0.5 mm.

In FIG. 2, while an example that the grooves 8 are disposed substantially perpendicular to the axial direction and in parallel with each other was shown, the grooves may be disposed in non-parallel with each other. Further, the grooves may be disposed obliquely with respect to the axial direction. In addition, each groove may be discontinuous along the circumferential direction and may be formed as groove portions with a predetermined gap there between. The grooves formed as the plural grooves disposed side by side in the axial direction may be replaced by a single continuous helical groove.

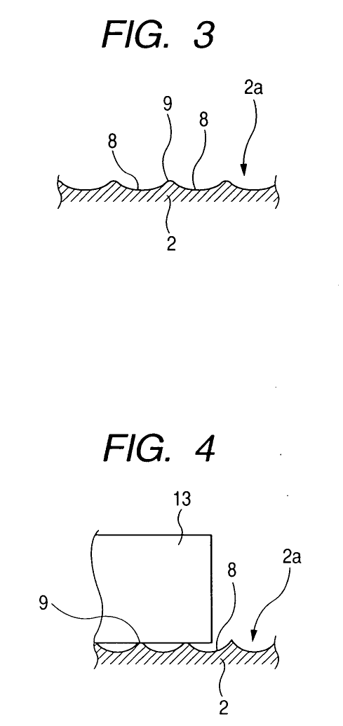

FIG. 3 is an enlarged partial sectional view of the grooves. The grooves 8 are formed in the outer peripheral track surface 2a of the inner race 2, for example, by cutting. Edge portions 9 are formed between the adjacent grooves 8. FIG. 4 is a sectional view showing a step for flattening the edge portions 9 of the grooves 8 by means of an urging tool. When the edge portions 9 are subjected to form rolling by using the urging tool or a forming roller 13, the edge portions 9 are deformed plastically, so that the edge portions 9 are substantially flattened or are reformed as curved land portions. As a result, the edge portions 9 are changed to smooth surfaces.

While the embodiment of the one-way clutch of sprag type using the sprags as the torque transmitting member was explained, it should be noted that the present invention can be applied to other type one-way clutches, for example, to a one-way clutch of roller type using rollers as torque transmitting members.

This application claims priority from Japanese Patent Application No. 2005-224054 filed Aug. 2, 2005 which is hereby incorporated by reference herein.

What is claimed is:

1. A one-way clutch comprising an outer race, an inner race rotatable relative to said outer race and a torque transmitting member for transmitting torque between said outer race and said inner race, wherein:
a plurality of grooves extending substantially in a circumferential direction are formed in an outer peripheral track surface of said inner race.

2. A one-way clutch according to claim 1, wherein said grooves are disposed at a pitch of 0.05 to 0.5 mm along an axial direction and each of said grooves has a depth of 0.05 to 0.5 mm and a width of 0.05 to 0.5 mm.

3. A method for manufacturing an inner race of a one-way clutch comprising the steps of:
forming a plurality of circumferential grooves in an outer peripheral surface of said inner race by cutting; and
plastically deforming the surface to obtain a smooth surface, by using an urging roller.

4. A method for manufacturing an inner race of a one-way clutch, according to claim 3, wherein said grooves are disposed at a pitch of 0.05 to 0.5 mm along an axial direction and each of said grooves has a depth of 0.05 to 0.5 mm and a width of 0.05 to 0.5 mm.
